(19) United States
(12) Patent Application Publication
(10) Pub. No.: US 2009/0200002 A1
(43) Pub. Date: Aug. 13, 2009

(54) HEAT EXCHANGER MEMBER AND PRODUCTION METHOD THEREOF

(75) Inventors: Kazuhiko Minami, Tochigi (JP); Ichiro Iwai, Tochigi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SHOWA DENKO K.K., Minato-ku (JP)

(21) Appl. No.: 11/815,217

(22) PCT Filed: Feb. 16, 2006
(86) PCT No.: PCT/JP2006/303213

§ 371 Date: Aug. 1, 2007

Related U.S. Application Data
(60) Provisional application No. 60/654,963, filed on Feb. 23, 2005.

(30) Foreign Application Priority Data
Feb. 16, 2005 (JP) 2005-038518

(51) Int. Cl. F28F 13/18; B05D 1/12; B23K 31/02

(52) U.S. Cl. 165/133; 427/180; 228/178

(57) ABSTRACT

A production method of a heat exchanger member to be brazed includes spraying particulate powder of metal less noble in corrosion potential than Al, an alloy of the metal, or a composition of the metal, at 150° C. or less at high speed onto a surface of a substrate of aluminum or its alloy to thereby make the particulate powder adhere to the surface. The metal is diffused in the surface layer portion of the substrate by the brazing heating to form a sacrificial corrosive layer.

This application claims priority to Japanese Patent Application No. 2005-38518 filed on Feb. 16, 2005 and U.S. Provisional Application Ser. No. 60/654,963 filed on Feb. 23, 2005, the entire disclosures of which are incorporated herein by reference in their entireties.

### CROSS REFERENCE TO RELATED APPLICATIONS

This application is an application filed under 35 U.S.C. §111(a) claiming the benefit pursuant to 35 U.S.C. §119(e)(1) of the filing date of U.S. Provisional Application Ser. No. 60/654,963 filed on Feb. 23, 2005, pursuant to 35 U.S.C. §111(b).

### TECHNICAL FIELD

The present invention relates to a heat exchanger member as a structural member of an aluminum heat exchanger to be manufactured by a brazing method, especially to a member preferably used as a member required to have good brazing performance and corrosion resistance. It also relates to a production method of such heat exchanger member.

### BACKGROUND ART

The following description sets forth the inventor's knowledge of related art and problems therein and should not be construed as an admission of knowledge in the prior art.

In order to improve the corrosion resistance of an aluminum heat exchanger, it is known to form a sacrificial corrosive layer by spraying Zn onto a surface of a tube. In this Zn sprayed tube, however, an even and thin adhesion of Zn cannot be attained because of the difficulty in stable spraying at a small adhering amount. Even if such a small adhering amount can be attained, the Zn cannot adhere to the tube surface evenly, thereby causing a mixture of adhering portions and non-adhering portions. Thus, there is a problem with a tube corrosion resistance. If the Zn adhering amount is increased for the purpose of eliminating the non-adhering portions, Zn will be incrassated to the fillet of the fin/tube connection, which in turn causes preferential corrosion of the fillet.

In view of the above, as a method for adhering Zn thinly and evenly, it is proposed to prevent fin detachment by substantially decreasing the adhering amount of Zn by spraying Al—Zn alloy or by making Zn adhere thinly and evenly by using Zn substitution flux (see, for example, JP H04-15496, A, JP 2003-225760, A).

In the Al—Zn spraying method, however, there was a problem that the Al—Zn wire was expensive. On the other hand, in the method of using flux showing Zn substitution reaction, the method requires a resin application step for applying resin as binder and a resin decomposition step for decomposing the resin components by heating at the time of brazing, which requires a big equipment change at the heating step.

As a heat exchanging tube, an extruded member is commonly used. However, in cases where there are die lines on a surface of the extruded tube, brazing material will flow along the die lines, which causes erosion by the brazing material.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

Other objects and advantages of the present invention will be apparent from the following preferred embodiments.

### DISCLOSURE OF INVENTION

The present invention has been developed in view of the above-mentioned and/or other problems in the related art. The present invention can significantly improve upon existing methods and/or apparatuses.

Among other potential advantages, some embodiments can provide a heat exchanger member excellent in brazing performance and low in cost.

Among other potential advantages, some embodiments can provide a method of producing a heat exchanger member which can be produced stably.

A method for producing a heat exchanger member according to the present invention has the structures as recited in the following Items [1] to [14].

[1] A production method of a heat exchanger member to be brazed, comprising the step of:

spraying particulate powder of metal less noble in corrosion potential than Al, an alloy of the metal or a composition of the metal at 150° C. or less at high speed onto a surface of a substrate of aluminum or its alloy to thereby make the particulate powder adhere to the surface.

[2] The production method of a heat exchanger member as recited in the aforementioned Item 1, wherein the substrate is an extruded member.

[3] The production method of a heat exchanger member as recited in the aforementioned Item 1 or 2, wherein a particle diameter of the particulate powder is 100 μm or less.

[4] The production method of a heat exchanger member as recited in the aforementioned Item 1 or 2, wherein an adhering amount of the metal is 0.3 to 6 g/m².

[5] The production method of a heat exchanger member as recited in the aforementioned Item 1 or 2, wherein the metal is Zn.

[6] The production method of a heat exchanger member as recited in the aforementioned Item 5, wherein the particulate powder is any one of particulate powder of Zn, Al—Zn alloy and KZnF₃.

[7] The production method of a heat exchanger member as recited in the aforementioned Item 1 or 2, wherein a particle velocity at the time of spraying is 100 to 400 m/sec.

[8] The production method of a heat exchanger member as recited in the aforementioned Item 1 or 2, wherein a distance between a nozzle of a spraying device for spraying the particulate powder and the substrate is 10 to 200 mm.

[9] The production method of a heat exchanger member as recited in the aforementioned Item 1 or 2, wherein an incident angle of the particulate powder with respect to the substrate is 15 to 90°.

[10] The production method of a heat exchanger member as recited in the aforementioned Item 1 or 2, wherein a nozzle of a spraying device for spraying the particulate powder is disposed at an angle of 45 to 135° with respect to a longitudinal direction of the substrate.

[11] The production method of a heat exchanger member as recited in the aforementioned Item 1 or 2, wherein two or more nozzles for spraying the particulate powder are used, and wherein an incident angle of the particulate powder from at least one nozzle with respect to the substrate is 30° or less and an incident angle of the particulate powder from at least one nozzle with respect to the substrate is 60° or more.

[12] The production method of a heat exchanger member as recited in the aforementioned Item 11, wherein the spraying is executed by spraying the particulate powder at an incident angle of 30° or less with respect to the substrate and then spraying the particulate powder at an incident angle of 60° or more with respect to the substrate.

[13] The production method of a heat exchanger member as recited in the aforementioned Item 1 or 2, wherein the heat exchanger member is a tube.

[14] A production method of a heat exchanger member to be brazed, comprising the step of:

spraying particulate powder of metal less noble in corrosion potential than Al, an alloy of the metal or a composition of the metal at 150° C. or less at high speed onto a surface of a substrate of aluminum or its alloy to thereby make the particulate powder adhere to the surface; and

heating the substrate with the particulate powder adhering thereto to form a sacrificial corrosive layer by dispersing the metal less noble in corrosion potential than Al into a surface layer portion of the substrate.

A heat exchanger member according to the present invention has the structure as recited in the following Items [15] and [16].

[15] A heat exchanger member, comprising:

a substrate of aluminum or its alloy with a surface to which particulate powder of metal less noble in corrosion potential than Al, an alloy of the metal or a composition of the metal is made to adhere to the surface of the substrate by high-speed spraying at 150° C. or less.

[16] A heat exchanger member, comprising:

a substrate of aluminum or its alloy; and

a sacrificial corrosive layer formed on a surface of the substrate by making particulate powder of metal less noble in corrosion potential than Al, an alloy of the metal or a composition of the metal adhere to the surface of the substrate by high-speed spraying at 150° C. or less and then heating the metal to be diffused in a surface layer portion of the substrate.

[17] A production method of a heat exchanger, comprising the steps of:

preparing tubes, each tube comprising a substrate of aluminum or its alloy with a surface to which particulate powder of metal less noble in corrosion potential than Al, an alloy of the metal or a composition of the metal is made to adhere to the surface of the substrate by high-speed spraying at 150° C. or less;

provisionally assembling a core portion by disposing the tubes and fins alternatively with the tubes connected to header tanks to form a provisional assembly; and

heating the provisional assembly for diffusing the metal less noble in corrosion potential than Al into a surface layer portion of the substrate to form a sacrificial corrosive layer and for brazing the tubes, the fins and the header tanks.

A method of producing a heat exchanger according to the present invention has the structure as recited in the following Item [18].

[18] A production method of a heat exchanger having a core portion in which tubes and fins are disposed alternatively and brazed each other and the tubes are connected and brazed to header tanks, the method comprising the steps of:

preparing tubes, each tube comprising a substrate of aluminum or its alloy with a surface to which particulate powder of metal less noble in corrosion potential than Al, an alloy of the metal or a composition of the metal is made to adhere to the surface of the substrate by high-speed spraying at 150° C. or less; and

heating a provisionally assembled core portion for diffusing the metal less noble in corrosion potential than Al into a surface layer portion of the substrate to form a sacrificial corrosive layer.

### EFFECTS OF THE INVENTION

With the method for producing a heat exchanger member according to the invention as recited in the aforementioned Item [1], by spraying the metal less noble in corrosion potential than Al onto the surface of the substrate, it is possible to make the metal adhere to the surface thinly and evenly. Since the metal forms a sacrificial corrosive layer by heating, a heat exchanger member excellent in corrosion resistance can be produced. Furthermore, the metal is made to adhere at a normal temperature, which simplifies the facility and steps for producing a heat exchanger member and can produce a heat exchanger member at low cost.

According to the invention as recited in the aforementioned Item [2], die liens existed on the substrate can be removed.

According to the invention as recited in the aforementioned Item [3], it makes it possible to make the particular powder adhere to the substrate without causing any scratches.

According to the invention as recited in each of the aforementioned Items [4], [5] and [6], superior corrosion resistance can be attained.

According to the invention as recited in each of the aforementioned Items [7] and [8], the adhering efficiency of the particulate powder is good.

According to the invention as recited in the aforementioned Item [9], the adhering efficiency of the particulate powder is good, and die liens can be removed sufficiently.

According to the invention as recited in the aforementioned Item [10], die liens can be removed sufficiently.

According to the invention as recited in each of the aforementioned Items [11] and [12], the adhering efficiency of the particulate powder is good, and die liens can be removed sufficiently.

According to the invention as recited in the aforementioned Items [13], a tube excellent in corrosion resistance can be produced.

According to the invention as recited in the aforementioned Items [14], the metal made to adhere to the surface of the substrate is diffused in the surface layer portion of the substrate to thereby form a sacrificial corrosion resistance layer.

The heat exchanger member according to the invention as recited in each of the aforementioned Items [15] and [16], excellent corrosion resistance can be attained.

According to the invention as recited in the aforementioned Items [17], the metal made to adhere to the surface of the substrate is diffused in the surface layer portion of the substrate to thereby form a sacrificial corrosion resistance layer. Thus, excellent corrosion resistance can be attained.

The heat exchanger according to the invention as recited in the aforementioned Item [18] is a heat exchanger excellent in corrosion resistance having a sacrificial corrosion resistance layer on the surface of the substrate.

### BRIEF DESCRIPTION OF DRAWINGS

The preferred embodiments of the present invention are shown by way of example, and not limitation, in the accompanying figures, in which:

FIG. 1 is a front view showing an embodiment of a heat exchanger to be produced in accordance with the present invention;

FIG. 2 is a cross-sectional view showing an embodiment of a heat exchanger member according to the present invention;

FIG. 3 is an explanatory view showing an incidence angle a of particulate powder in a production method of a heat exchanger member according to the present invention;

FIG. 4 is an explanatory view showing a disposing angle β of a nozzle of a spraying device with respect to a substrate in a production method of a heat exchanger member according to the present invention; and

FIG. 5 is an explanatory view showing a nozzle layout example in an embodiment.

### BEST MODE FOR CARRYING OUT THE INVENTION

In the following paragraphs, some preferred embodiments of the invention will be described by way of example and not limitation. It should be understood based on this disclosure that various other modifications can be made by those in the art based on these illustrated embodiments.

A heat exchanger member to be manufactured in accordance with the method of the present invention is to be secured to other members by brazing, and is a member in which metal less noble in corrosion potential than Al adheres to a surface of a substrate constituting the member. In a heat exchanger member with the metal adhering thereto, the metal will be diffused in the surface layer portion of the substrate by heating, e.g., heating at the time of brazing, thereby forming a sacrificial corrosive layer.

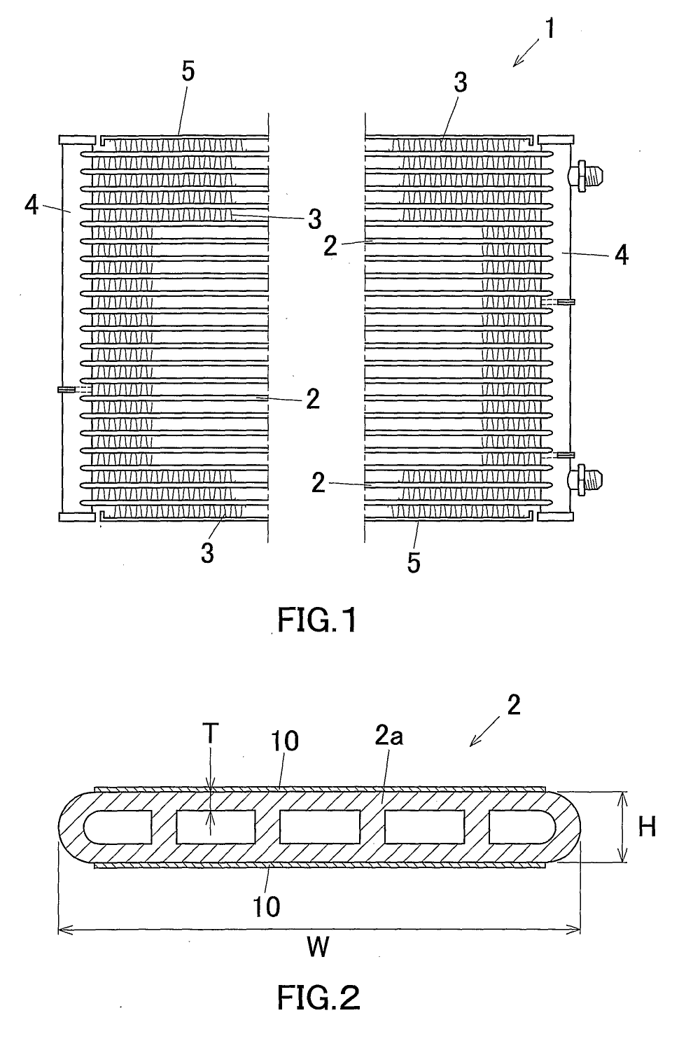

The present invention can be applied to any heat exchanger members. For example, in a heat exchanger as shown in FIG. 1, a core portion of a heat exchanger 1 is formed by brazing tubes 2 and fins 3, and tubes 2 and header tanks 4 in a state in which tubes 2 and fins 3 are disposed alternatively with the end portions of the tubes 2 connected to respective header tanks 4. A heat exchanger member according to the present invention can be any one of the tubes 2, fins 3 and header tanks 4. Among other things, it can be preferably applied to the tube 2. In the heat exchanger 1 as recited in FIG. 1, a side plate 5 is brazed to the outermost fin 3.

As shown in FIG. 2, in a situation prior to brazing, a metal adhering layer 10 of metal particulate powder is formed on the surface of the substrate 2a of the tube 2 made of aluminum or its alloy. The metal constituting the metal adhering layer 10 will be diffused in the substrate 2a by brazing heating to form a sacrificial corrosive layer.

In the present invention, it should be noted that the heat exchanger member is not limited to a tube as illustrated, and can be a fin, a header tank, etc. Although the production method of the substrate 2a is not specifically limited, the substrates 2a can preferably be an extruded member because of the following reasons. That is, as will be explained later, die lines can be removed by high-speed spraying of particulate powder, and therefore the application of the present invention to an extruded member will be of great significance.

The material of the substrate 2a is not limited so long as it is aluminum or its alloy, and can be used any known material. As the tube material, JIS 1xxx series aluminum alloy, Aluminum alloy including a small amount of Cu and Mn, JIS 3xxx series aluminum alloy can be recommended. As the fin material, aluminum alloy in which Zn is added to JIS 3xxx series aluminum alloy can be recommended. As the header tank material, JIS 3003 alloy can be recommended.

The metal adhering layer 10 can be formed at normal temperature by, for example, spraying metal particulate powder through a nozzle of a spraying device together with a carrier gas at high speed so that the particulate powder is collided against the surface of the substrate 2a to thereby adhere to the surface. Since the spraying is executed at 150° C. or below, the metallic powder can be made to adhere more thinly and evenly as compared with the case in which the metal adhering layer is formed by thermally spraying metallic powder.

The metal constituting the metal adhering layer 10 can form a sacrificial corrosive layer in cases where the metal is less noble in corrosion potential than Al. As such metal, Zn, In and Sn can be exemplified. Among other things, Zn can be recommended because of the low cost. These metals can be used as an alloy or a composition as well as a metal as a simple substance. In the case of Zn, Al—Zn alloy, KZnF₃, ZnF₂, and ZnCl₂ can be exemplified. Among other things, any one of Zn, Al—Zn alloy and KZnF₃ can be recommended. As to the particulate powder, one type of powder or a combination of plural types of powder can be used.

Although the particle diameter of the particulate powder is not specifically limited, if the particle diameter is too larger, the particles can cut deep into the substrate 2a, causing damage to the substrate 2a. The preferable particle diameter is 100 μm or less, more preferably 50 μm or less. The adhering amount of the metal should be an amount capable of securing corrosion resistance and preferably falls within the range of from 0.3 to 6 g/cm². If it is less than 0.3 g/m², sufficient corrosion resistance cannot be attained. To the contrary, if it exceeds 6 g/m², fillet portions can be corroded preferentially, which is uneconomical. It is more preferable that the adhering amount falls within the range of 1 to 5 g/m². In cases of making the metal adhere to the substrate 2a as any one of a metal simple substance, an alloy and a composition, the aforementioned adhering amount denotes a net content of the element of the metal. For example, in cases of making Al—Zn alloy or KZnF₃ adhere to the substrate 2a, the aforementioned adhering amount denotes the Zn amount.

The preferable spraying conditions of the particulate powder are as follows.

The particle velocity at the time of spraying the particulate powder is a factor which influences the adhesion of the particulate powder, and is preferably set to 100 to 400 m/sec. If the particle velocity is slower than 100 m/sec., the amount of particulate powder which will drop without adhering to the substrate 2a increases, resulting in poor adherence efficiency, which is uneconomical. On the other hand, if it exceeds 400 m/sec., it is not preferable because the high velocity particles may cause deformation of the substrate 2a due to its collision impact. It is more preferable that the particle velocity falls within the range of from 100 to 250 m/sec.

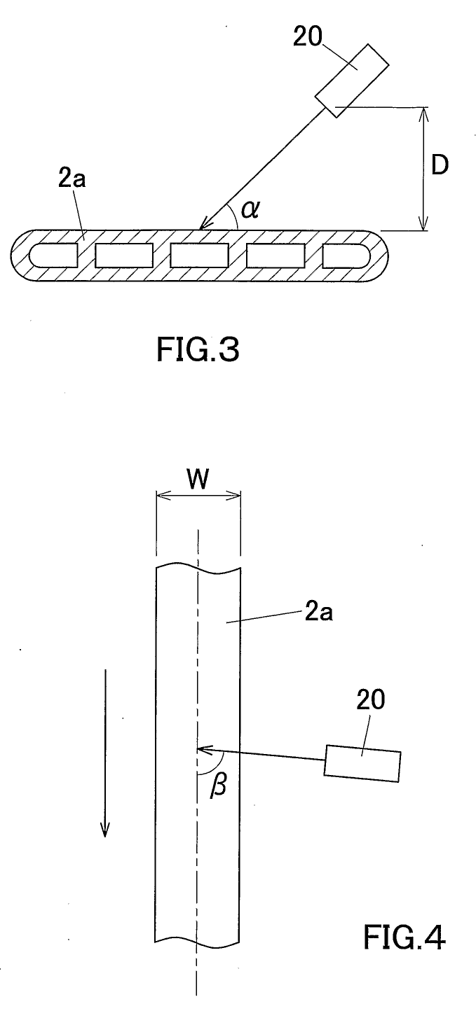

The distance D between the nozzle 20 of the spraying device and the substrate 2a shown in FIG. 3 is a factor which influences the particle velocity, which in turn influences the adhesion of the particulate powder. Accordingly, it is preferable to dispose the nozzle 20 such that the distance D between the nozzle 20 and the substrate 2a falls within the range of from 10 to 200 mm. If the distance D is less than 10 mm, the particulate powder will not be accelerated sufficiently. On the other hand, if it exceeds 200 mm, the particle velocity will deteriorate due to air resistance. Accordingly, falling out of the range causes deterioration of the adhering efficiency. It is more preferable that the distance between the nozzle 20 and the substrate 2a falls within the range of from 20 to 150 mm.

The incident angle a of the particulate powder with respect to the substrate 2a shown in FIG. 3 is a factor which influences the adhesion efficiency of the particulate powder and the smoothening of die lines, and preferably falls within the range of from 15 to 90°. More preferably, it is less than 90°. If die lines exist on a surface of an extruded member, brazing material melted at the time of brazing will be led to certain portions along the die lines, which may cause erosion of the portions. Accordingly, it is preferable to form the metal adhering layer 10 by spraying particulate powder to delete die lines. If the incident angle a of the particulate powder is less than 15°, a number of particles will drop from the surface of the substrate 2a after the collision due to the smaller incident angle, resulting in deteriorated adhering efficiency. On the other hand, if the incident angle a is 90°, the die line smoothening effect is poor, which may result in insufficient removal of die lines. The more preferable incident angle a is 15 to 65°. In the case of an extruded member with no die line or a substrate with no scratch causing erosion, no incident angle is limited.

The angle β of the nozzle with respect to the longitudinal direction of the substrate 2a shown in FIG. 4 is a factor which influences the removal of die lines and the generation of erosion at the time of brazing. The angle β is preferably set to 45 to 135°. If the angle β is less than 45° or exceeds 135°, die lines may not be removed sufficiently and linear dented portions may be formed along the longitudinal direction due to the spraying. If die lines remain or linear dented portions are formed, brazing material melted at the time of brazing will be led by them to certain portions, which may cause generation of erosion. The preferable angle β of the nozzle 20 with respect to the longitudinal direction of the substrate 2a is 60 to 120°. In the case of spraying the particulate powder against the traveling substrate 2a, the longitudinal direction of the substrate 2a denotes the traveling direction as shown by an arrow in FIG. 4.

The high-speed spraying of the particulate powder can be performed using two or more nozzles with respect to one surface. In the case of using two or more nozzles, adhesion of particulate powder and deletion of die lines can be assuredly performed by spraying particulate powder from plural different angles. In detail, for example, high-speed spraying from at least one nozzle is performed at an incident angle of 30° or less to delete die lines, and high-speed spraying from at least one nozzle is performed at an incident angle of 60° or more to secure metal adhering amount. In the case of using three or more nozzles, the number of nozzles for respective incident angles can be arbitrarily set. It is preferable to initially delete die lines by spraying particulate powder at an incident angle of 30° or less and then to secure the metal adhering amount by spraying particulate powder at an incident angle of 60° or more since both deleting of die lines and securing of metal adhering amount can be attained efficiently.

Although the types of carrier gas for spraying the particulate powder at high-speed are not specifically limited, air, nitrogen gas, carbon dioxide gas and argon gas can be exemplified. For the purpose of preventing oxidization of the particulate powder, it is preferable to execute the spraying in a non-oxidizing atmosphere such as a nitrogen atmosphere or an argon gas atmosphere.

In the heat exchanger member 2 illustrated in FIG. 2, the metal adhering layer 10 is formed on each of the upper and lower surfaces of the substrate 2a. In the present invention, however, the number of surfaces to which particulate powder is be sprayed at high speed and the spraying region of a surface are not limited. The high-speed spraying can be applied to any surface and any region.

Since the aforementioned high-speed spraying is to be executed at 150° C. or below, the equipment and steps can be simplified as compared with a conventional thermal spraying, thereby enabling manufacturing of a heat exchanger member at low cost. Furthermore, the high-speed spraying can simplify the steps since excellent adhesion of particulate powder can be attained without executing any pre-treatment of the surface of the substrate.

The heat exchanger 1 is produced by heating the provisional assembly of the tubes 2, fins 3 and header tanks 4 to braze them. The heating temperature at the time of brazing is preferably 580 to 620° C. The sacrificial corrosive layer due to diffusion of metal can be formed by the heating of 400° C. or above. The heating at the time of brazing causes formation of a sacrificial corrosive layer at the surface layer portion of the tube 2. By this sacrificial corrosive layer, the heat exchanger 1 of the present invention becomes excellent in corrosion resistance.

### EXAMPLES

### Example

As the material of the substrate 2a of a heat exchanging tube 2, JIS 1xxx series aluminum alloy (Cu: 0.4 mass %, Mn: 0.2 mass %, the balance being Al and inevitable impurities) was used. An aluminum alloy billet of the aforementioned composition was subjected to soaking and then extruded into a multi-bored flat tube 2a (width W: 16 mm, a height H: 3 mm, thickness T: 0.5 mm) as shown in FIG. 2 to form a coil.

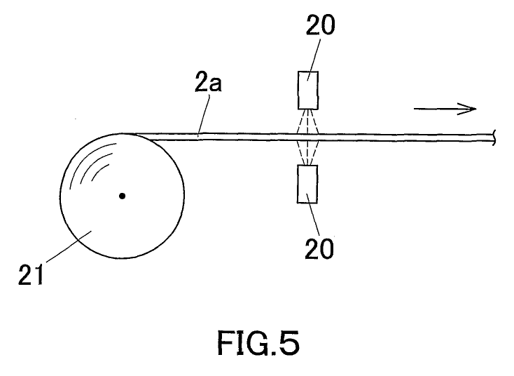

Then, as shown in FIG. 5, various metal particulate powder were sprayed at high speed at 150° C. or below from nozzles 20 disposed at the upper and lower positions of the multi-bored flat tube 2a onto the upper and lower flat surfaces of the tube 2a while unwinding the coiled tube 2a to thereby form metal adhering layers 10. The material and particle diameter of the particulate powder used in each Example are shown in Table 1.

In Examples Nos. 1 to 9, an upper nozzle 20 and a lower nozzle 20 were used. Each nozzle was disposed such that the angle β with respect to the longitudinal direction (traveling direction) of the multi-bored flat tube 2a (see FIG. 4) was set to 20° (Example No. 7) or 90° (Examples other than Example No. 7) and the angle between the axis of the spray and the flat surface, i.e., the incident angle a of the particulate powder (see FIG. 3) was set to 90° (Example No. 6) or 45° (Examples other than Example No. 6) by inclining the nozzle 20 with respect to the flat surface of the flat tube 2a.

In Examples Nos. 10 to 12, two nozzles 20 were disposed at upper and lower positions of the multi-bored flat tube 2a along the traveling direction of the tube, respectively (not shown). Each of the nozzles 20 was disposed such that the angle β with respect to the longitudinal direction (traveling direction) was set to the angle shown in Table 1. Furthermore, the incident angles a of the particulate powder at the above and below of the tube 2a were set to the angle shown in Table 1, respectively. That is, the particulate powder was sprayed at high speed at two different angles. The high-speed spraying at the smaller incident angle was executed and then the high-speed spraying at the larger incident angle was executed. The distance of each nozzle 20 and the multi-bored flat tube 2a and the particle velocity were set as shown in Table 1.

By the aforementioned high-speed spraying of the particulate powder, a metal adhering layer 10 was formed on each of the upper and lower flat surfaces of the multi-bored flat tube 2a. The net Zn adhering amount became as shown in Table 1. Subsequent to the high-speed spraying, the tube 2a was cut into a predetermined length to thereby obtain a tube 2.

### Comparative Example 1

As the material of the multi-bored tube, the same aluminum alloy as Examples was used. A spraying nozzle was disposed at the exit side of an extruder. To the upper and lower flat surfaces of the extruded multi-bored flat tube 2a, Al—Zn spraying was executed using an Al—Zn alloy wire. After cooling in a cooling water tank, the tube 2a was continuously coiled. The Zn adhering amount of the Al—Zn spraying became as shown in Table 1. Then, while uncoiling, the coiled tube was cut into a predetermined length to obtain a tube.

### Comparative Example 2

Using the same aluminum alloy as Examples as the material of the multi-bored flat tube, a multi-bored flat tube 2a was extruded and cut into a predetermined length.

A composite in which KZnF₃ and acrylic resin as binder were mixed at a mass ratio of 1:2 was applied to the upper and lower flat surfaces of the multi-bored flat tube. The Zn adhering amount became as shown in Table 1.

The produced tubes 2 of each Example, brazing fins 3 and header tanks 4 are provisionally assembled and then brazed to obtain a heat exchanger 1 as shown in FIG. 1. The brazing heating was executed at the condition of 600° C.×10 min. This heating caused diffusion of Zn into the surface layer portion of the tube 2, forming a sacrificial corrosive layer.

The tubes of Comparative Example 1, brazing fins 3 and header tanks 4 are provisionally assembled and then brazed by the heating of 600° C.×10 min to obtain a heat exchanger 1.

Using the tubes of Comparative Example 2, a heat exchanger was obtained by brazing in the same manner as mentioned above. By this heating, Zn in the applied KZnF₃ was diffused, thereby forming a sacrificial corrosive layer at the surface layer portion.

As to each brazed heat exchanger, corrosion resistance and brazing performance (erosion) were evaluated by the following test method.

### <Corrosion Resistance>

Each of the obtained heat exchangers was subjected to the SWAAT test regulated in ASTM-G85-A3. As corrosion test liquid, test liquid of pH3 adjusted by adding acetic acid to artificial seawater of ASTM D1141 was used. The test was executed for 480 hours by repeating a cycle of spraying for 0.5 hour and holding the moistened state for 1.5 hours. Furthermore, as to the test pieces attained excellent result by the 480-hour-corrosion-test, by executing an additional 480-hour-corrosion-test, a corrosion resistance test of a total of 960 hours was executed.

After the aforementioned corrosion resistance test, the corrosion resistance was evaluated.

⊚: No preferential corrosion occurred in filets; relatively good results among long corrosion tests (960-hour-corrosion-tests).

∘: Maximum corrosion depth was approximately the same as the above (i.e., ⊚): good result in the main corrosion resistance test (480-hour-corrosion-rest)

Δ: Maximum corrosion depth was not smaller than 150 μm but not larger than 250 μm

x: Pitting corrosion occurred; corrosion depth was 200 μm or more

### <Brazing Performance (Erosion)>

Brazing performance was evaluated by the following standard based on the erosion generation status.

⊚: No erosion was observed

∘: Erosion of 10 μm or less in thickness was generated in a tube wall

Δ: Erosion of 10 μm or more but 50 μm or less in thickness was generated in a tube wall

x: Erosion penetrating a tube wall or Erosion of 50 μm or more in thickness was generated in a tube wall

TABLE 1

| | | Particulate powder | | High-speed spraying conditions | | | | | Zn | | | |
|---|---|---|---|---|---|---|---|---|---|---|---|---|
| | | | Particle | Number | Distance | Particle | Particle | Nozzle | adhering | | Brazing | |
| | | | diameter | of | D | velocity | incident | angle | amount | Corrosion | perfor- | |
| No. | | Material | (μm) | nozzles | (mm) | (m/sec) | angle α(°) | β(°) | (g/m²) | resistance | mance | Remarks |
| Example | 1 | Zn | 40 | 1 | 40 | 150 | 45 | 90 | 1.5 | ⊚ | ⊚ | |
| | 2 | Zn | 120 | 1 | 60 | 200 | 45 | 90 | 2 | ⊚ | ◯ | |
| | 3 | Zn | 30 | 1 | 50 | 180 | 45 | 90 | 10 | ◯ | ⊚ | |
| | 4 | Zn | 40 | 1 | 5 | 200 | 45 | 90 | 3 | ◯ | ◯ | |
| | 5 | Zn | 30 | 1 | 30 | 600 | 45 | 90 | 2 | ◯ | ◯ | |
| | 6 | Zn | 40 | 1 | 70 | 200 | 90 | 90 | 2.5 | ◯ | Δ | |
| | 7 | Zn | 40 | 1 | 100 | 250 | 45 | 20 | 3 | ⊚ | Δ | |
| | 8 | KZnF₃ | 30 | 1 | 30 | 200 | 45 | 90 | 1 | ⊚ | ⊚ | |
| | 9 | Al—Zn | 30 | 1 | 40 | 180 | 45 | 90 | 3 | ⊚ | ⊚ | |
| | 10 | Zn | 30 | 2 | 30 | 200 | 30, 75 | 90 | 2 | ⊚ | ⊚ | |
| | 11 | KZnF₃ | 10 | 2 | 40 | 180 | 20, 80 | 90 | 2 | ⊚ | ⊚ | |
| | 12 | Al—Zn | 30 | 2 | 30 | 200 | 20, 80 | 90 | 2 | ⊚ | ⊚ | |

| | | | | | | |
|---|---|---|---|---|---|---|
| Comp. | 1 | Thermally spraying Al—Zn | 3 | ◯ | Δ | *1 |
| Ex. | 2 | Applying KZnF₃ + Binder | 2 | | Poor | *2 |
| | | | | | brazing | |

*1: Al—Zn thermal spraying wire, High cost
*2: Equipment for dissolving binder at the time of brazing is required, Condition setting is required

In the tube of each Example, a small amount of Zn was made evenly adhere to the surface of the substrate, resulting in thin and even sacrificial corrosive layer by brazing heating. From the results shown in Table 1, it was confirmed that excellent corrosion resistance and brazing performance were obtained by the formed sacrificial corrosive layer. Furthermore, it was lower in cost as compared to the formation of the sacrificial corrosive layer by the thermal spraying of Comparative Example 1. In Comparative Example 2, since brazing was poor under the same equipment and conditions as in the present invention, it was not necessary to execute the corrosion resistance test.

### INDUSTRIAL APPLICABILITY

A heat exchanger member manufactured by the method of the present invention is excellent in corrosion resistance and brazing performance, and therefore it can be preferably applied to a structural member of various types of heat exchangers.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

1. A production method of a heat exchanger member to be brazed, comprising the step of:
spraying particulate powder of metal less noble in corrosion potential than Al, an alloy of the metal or a composition of the metal at 150° C. or less at high speed onto a surface of a substrate of aluminum or its alloy to thereby make the particulate powder adhere to the surface.

2. The production method of a heat exchanger member as recited in claim 1, wherein the substrate is an extruded member.

3. The production method of a heat exchanger member as recited in claim 1, wherein a particle diameter of the particulate powder is 100 μm or less.

4. The production method of a heat exchanger member as recited in claim 1, wherein an adhering amount of the metal is 0.3 to 6 g/m².

5. The production method of a heat exchanger member as recited in claim 1, wherein the metal is Zn.

6. The production method of a heat exchanger member as recited in claim 5, wherein the particulate powder is any one of particulate powder of Zn, Al—Zn alloy and KZnF₃.

7. The production method of a heat exchanger member as recited in claim 1, wherein a particle velocity at the time of spraying is 100 to 400 m/sec.

8. The production method of a heat exchanger member as recited in claim 1, wherein a distance between a nozzle of a spraying device for spraying the particulate powder and the substrate is 10 to 200 mm.

9. The production method of a heat exchanger member as recited in claim 1, wherein an incident angle of the particulate powder with respect to the substrate is 15 to 90°.

10. The production method of a heat exchanger member as recited in claim 1, wherein a nozzle of a spraying device for spraying the particulate powder is disposed at an angle of 45 to 135° with respect to a longitudinal direction of the substrate.

11. The production method of a heat exchanger member as recited in claim 1, wherein two or more nozzles for spraying the particulate powder are used, and wherein an incident angle of the particulate powder from at least one nozzle with respect to the substrate is 30° or less and an incident angle of the particulate powder from at least one nozzle with respect to the substrate is 60° or more.

12. The production method of a heat exchanger member as recited in claim 11, wherein the spraying is executed by spraying the particulate powder at an incident angle of 30° or less with respect to the substrate and then spraying the particulate powder at an incident angle of 60° or more with respect to the substrate.

13. The production method of a heat exchanger member as recited in claim 1, wherein the heat exchanger member is a tube.

14. A production method of a heat exchanger member to be brazed, comprising the step of:
spraying particulate powder of metal less noble in corrosion potential than Al, an alloy of the metal or a composition of the metal at 150° C. or less at high speed onto a surface of a substrate of aluminum or its alloy to thereby make the particulate powder adhere to the surface; and
heating the substrate with the particulate powder adhering thereto to form a sacrificial corrosive layer by dispersing the metal less noble in corrosion potential than Al into a surface layer portion of the substrate.

15. A heat exchanger member, comprising:
a substrate of aluminum or its alloy with a surface to which particulate powder of metal less noble in corrosion potential than Al, an alloy of the metal or a composition of the metal is made to adhere to the surface of the substrate by high-speed spraying at 150° C. or less.

16. A heat exchanger member, comprising:
a substrate of aluminum or its alloy; and
a sacrificial corrosive layer formed on a surface of the substrate by making particulate powder of metal less noble in corrosion potential than Al, an alloy of the metal or a composition of the metal adhere to the surface of the substrate by high-speed spraying at 150° C. or less and then heating the metal to be diffused in a surface layer portion of the substrate.

17. A production method of a heat exchanger, comprising the steps of:
preparing tubes, each tube comprising a substrate of aluminum or its alloy with a surface to which particulate powder of metal less noble in corrosion potential than Al, an alloy of the metal or a composition of the metal is made to adhere to the surface of the substrate by high-speed spraying at 150° C. or less;
provisionally assembling a core portion by disposing the tubes and fins alternatively with the tubes connected to header tanks to form a provisional assembly; and
heating the provisional assembly for diffusing the metal less noble in corrosion potential than Al into a surface layer portion of the substrate to form a sacrificial corrosive layer and for brazing the tubes, the fins and the header tanks.

18. A production method of a heat exchanger having a core portion in which tubes and fins are disposed alternatively and brazed each other and the tubes are connected and brazed to header tanks, the method comprising the steps of:
preparing tubes, each tube comprising a substrate of aluminum or its alloy with a surface to which particulate powder of metal less noble in corrosion potential than Al, an alloy of the metal or a composition of the metal is made to adhere to the surface of the substrate by high-speed spraying at 150° C. or less; and
heating a provisionally assembled core portion for diffusing the metal less noble in corrosion potential than Al into a surface layer portion of the substrate to form a sacrificial corrosive layer.
